(19) United States
(12) Patent Application Publication
(10) Pub. No.: US 2011/0244238 A1
(43) Pub. Date: Oct. 6, 2011

(54) METHOD FOR PRODUCING HIGH-PURITY SIO2 FROM SILICATE SOLUTIONS

(76) Inventors: Christian Panz, Wesseling-Berzdorf (DE); Markus Ruf, Alfter-Witterschlick (DE); Guido Titz, Heimbach (DE); Florian Paulat, Bruhl (DE); Hartwig Rauleder, Rheinfelden (DE); Sven Müller, Bonn (DE); Jürgen Behnisch, Rheinbach (DE); Jens Peltzer, Grafschaft (DE)

(21) Appl. No.: 13/121,751

(22) PCT Filed: Sep. 28, 2009
(86) PCT No.: PCT/EP2009/062508

§ 371 Date: Jun. 8, 2011

Related U.S. Application Data
(60) Provisional application No. 61/111,125, filed on Nov. 4, 2008.

(30) Foreign Application Priority Data
Sep. 30, 2008 (DE) 102008049597.2

(51) Int. Cl. B32B 3/00; C01B 33/12

(52) U.S. Cl. 428/402; 423/339; 423/335

(57) ABSTRACT

The invention relates to a novel method for producing high-purity SiO₂ from silicate solutions, a novel high-purity SiO₂ with a specific impurity profile and use thereof.

The present invention relates to a novel method for the production of high purity SiO₂ from silicate solutions, to a novel high purity SiO₂ with a specific impurity profile and to the use thereof.

The proportion of photovoltaic cells used worldwide in power production has been growing continuously for some years. If further growth in market share is to be achieved, it is essential for the costs involved in producing photovoltaic cells to be reduced and their efficiency to be increased.

A significant cost factor in the production of photovoltaic cells is the cost of high purity silicon (solar silicon), which is conventionally produced on a large industrial scale using the Siemens method developed over 50 years ago. In this method silicon is firstly reacted with gaseous hydrogen chloride at 300-350° C. in a fluidized bed reactor to yield trichlorosilane (silico-chloroform). After complex distillation steps, the trichlorosilane is decomposed thermally again in the presence of hydrogen by reversal of the above reaction on heated superpure silicon rods at 1000-1200° C. In the process, the elemental silicon grows onto the rods and the liberated hydrogen chloride is recirculated. Silicon tetrachloride arises as a byproduct, this either being converted into trichlorosilane and returned to the process or combusted in an oxygen flame to yield pyrogenic silica.

A chlorine-free alternative to the above method is the decomposition of monosilane, which may likewise be obtained from the elements and dissociates again after a purification step performed on heated surfaces or on passage through fluidized bed reactors. Examples thereof may be found in WO 2005118474 A1.

The polycrystalline silicon (polysilicon) obtained in the ways described above is suitable for the production of solar panels and has a purity of over 99.99%. However, the above-described methods are very complex and energy-intensive, such that there is considerable need for a cheaper, more efficient method of producing solar silicon.

Since silicate solutions are available in very large quantities as a very inexpensive raw material, there has been no shortage in the past of attempts to produce SiO₂ from silicate solutions and convert it into silicon by reduction. For instance, methods have been described in U.S. Pat. No. 4,973,462 in which highly viscous water glass was reacted with an acidulant at a low pH value of the reaction solution to yield SiO₂. This SiO₂ was then filtered, washed with water, resuspended in a mixture of acid, water and a chelating reagent, repeatedly filtered and washed. JP02-311310 described a similar method, but in this case a chelating reagent was added as early as during the precipitation reaction. These two methods have the disadvantage that they involve a very complex working up procedure. It has additionally been found that the precipitates obtained after precipitation are in part difficult to filter. Finally, additional costs are incurred for the chelating reagent and separation thereof from the silicon dioxide.

WO 2007/106860 A1 proposes a method in which first of all phosphorus and boron impurities are removed from water glass and an acid by ion exchange columns, after which the water glass and acid are reacted to yield SiO₂. This SiO₂ is then reacted with carbon to yield elemental silicon. This method has the disadvantage that primarily only boron and phosphorus impurities are eliminated from the water glass. In order to obtain sufficiently pure solar silicon, however, metallic impurities have in particular also to be separated out. WO 2007/106860A1 proposes in this respect to use further ion exchange columns in the process. However, this results in a very complex, expensive process with a low space-time yield.

There is thus still a need for an efficient and inexpensive method of producing high purity silicon dioxide which may be used for the production of solar silicon.

It was accordingly an object of the present invention to provide a novel method for the production of high purity silicon dioxide which lacks at least some of the disadvantages of the above-stated methods or exhibits them only to a lesser degree. It was also an object to provide novel high purity silicon dioxide which is particularly well suited to the production of solar silicon. Further objects which are not explicitly stated are revealed by the overall context of the following description, examples and claims.

These objects are achieved by the method described in the following description, examples and claims and the high purity silicon dioxide described therein.

The inventors have surprisingly found that it is possible to produce high purity silicon dioxide simply by specific process control, without a plurality of additional purification steps, for example, calcining or chelating and without special apparatus. A significant feature of the method is control of the pH value of the silicon dioxide and of the reaction media in which the silicon dioxide is located during the various method steps. Without being tied to any particular theory, the inventors are of the opinion that a very low pH value ensures that ideally no free, negatively charged SiO groups are present on the silicon dioxide surface onto which troublesome metal ions may become attached. At a very low pH value the surface is even positively charged, such that metal cations are repelled by the silica surface. Providing the pH value is very low, it is possible to prevent these metal ions, if they are then washed out, from becoming attached to the surface of the silicon dioxide according to the invention. If the silica surface is a positively charged, silica particles are then also prevented from becoming attached to one another and so forming cavities in which impurities could be deposited. The method according to the invention may thus be carried out without using chelating reagents or ion exchange columns. Calcining steps may also be dispensed with. The present method is thus substantially simpler and less expensive than prior art methods.

A further advantage of the method according to the invention is that it can be performed in conventional apparatus.

The present invention accordingly provides a method for the production of high purity silicon dioxide, comprising the following steps
a. producing an initial charge of an acidulant, or an acidulant with water, with a pH value of less than 2, preferably less than 1.5, particularly preferably less than 1, very particularly preferably less than 0.5
b. providing a silicate solution with a viscosity of 0.1 to 2 poise
c. adding the silicate solution from step b. to the initial charge from step a. in such a way that the pH value of the resultant precipitation suspension remains at all times at a value of less than 2, preferably less than 1.5, particularly preferably less than 1 and very particularly preferably less than 0.5
d. separating and washing the resultant silicon dioxide, the washing medium having a pH value of less than 2, preferably less than 1.5, particularly preferably less than 1 and very particularly preferably less than 0.5
e. drying the resultant silicon dioxide

The present invention additionally provides a silicon dioxide, characterized in that it has a content of
a. aluminum of between 0.001 and 5 ppm
b. boron of less than 1 ppm
c. calcium of less than or equal to 1 ppm
d. iron of less than or equal to 5 ppm
e. nickel of less than or equal to 1 ppm
f. phosphorus of less than 1 ppm
g. titanium of less than or equal to 5 ppm
h. zinc of less than or equal to 1 ppm
   and in that the total of the abovementioned impurities plus sodium and potassium amounts to less than 10 ppm.

Finally, the present invention provides use of the silicon dioxides according to the invention for the production of solar silicon, as a high purity raw material for the production of high purity silica glass for optical waveguides or glassware for laboratories and electronics and as a starting material for the production of high purity silica sols for polishing slices of high purity silicon (wafers).

The method according to the invention for the production of high purity silicon dioxide comprises the following steps
a. producing an initial charge of an acidulant, or an acidulant with water, with a pH value of less than 2, preferably less than 1.5, particularly preferably less than 1, very particularly preferably less than 0.5
b. providing a silicate solution with a viscosity of 0.1 to 2 poise
c. adding the silicate solution from step b. to the initial charge from step a. in such a way that the pH value of the precipitation suspension remains at all times at a value of less than 2, preferably less than 1.5, particularly preferably less than 1 and very particularly preferably less than 0.5
d. separating and washing the resultant silicon dioxide, the washing medium having a pH value of less than 2, preferably less than 1.5, particularly preferably less than 1 and very particularly preferably less than 0.5.
e. drying the resultant silicon dioxide

In step a) an initial charge of an acidulant or an acidulant and water is produced in the precipitation vessel. The water used for the purposes of the present invention is preferably distilled or deionized water. The acidulant may be the acidulant which is also used in step d) for washing the filter cake. The acidulant may be hydrochloric acid, phosphoric acid, nitric acid, sulfuric acid, chlorosulfonic acid, sulfuryl chloride or perchloric acid in concentrated or dilute form or mixtures of the above-stated acids. In particular, hydrochloric acid may be used, preferably 2 to 14 N, particularly preferably 2 to 12 N, very particularly preferably 2 to 10 N, especially preferably 2 to 7 N and very especially preferably 3 to 6 N, phosphoric acid, preferably 2 to 59 N, particularly preferably 2 to 50 N, very particularly preferably 3 to 40 N, especially preferably 3 to 30 N and very especially preferably 4 to 20 N, nitric acid, preferably 1 to 24 N, particularly preferably 1 to 20 N, very particularly preferably 1 to 15 N, especially preferably 2 to 10 N, sulfuric acid, preferably 1 to 37 N, particularly preferably 1 to 30 N, very particularly preferably 2 to 20 N, especially preferably 2 to 10 N. Sulfuric acid is very particularly preferably used.

In a preferred variant of the method according to the invention, a peroxide is added to the initial charge in step a) in addition to the acidulant, which peroxide brings about a yellow/orange coloration with titanium(IV) ions under acidic conditions. In this case, the peroxide is particularly preferably hydrogen peroxide or potassium peroxydisulfate. As a result of the yellow/orange coloration of the reaction solution, the degree of purification during washing step d) may be very closely monitored. It has in fact emerged that titanium in particular constitutes a very tenacious contaminant, which becomes readily attached to the silicon dioxide at pH values of over 2. The inventors have found that disappearance of the yellow/orange coloration in step d) normally means that the desired purity of the silicon dioxide has been reached and the silicon dioxide may be washed from this point with distilled or deionized water until a neutral pH value is achieved for the silicon dioxide. In order to achieve this indicator function of the peroxide, it is also possible to add the peroxide not in step a) but rather to the water glass in step b) or as a third material stream in step c). In principle it is possible to add the peroxide only after step c) and before step d) or during step d). The present inventions provide all the above-stated variants and mixed forms thereof. However, preferred variants are those in which the peroxide is added in step a) or b), since in this case it can exercise a further function in addition to the indicator function. Without being tied to any particular theory, the inventors are of the opinion that some, in particular carbon-containing, impurities are oxidized by reaction with peroxide and removed from the reaction solution. Other impurities are converted by oxidation into a more readily soluble form, which can therefore be washed out. The method according to the invention therefore has the advantage that no calcining step has to be performed, although this is of course a possible option.

In step b) a silicate solution with a viscosity of 0.1 to 2 poise, preferably of 0.2 to 1.9 poise, particularly of 0.3 to 1.8 poise and especially preferably of 0.4 to 1.6 poise and very especially preferably of 0.5 to 1.5 poise is provided. An alkali metal and/or alkaline earth metal silicate solution may be used as the silicate solution, an alkali metal silicate solution preferably being used, particularly preferably sodium silicate (water glass) and/or potassium silicate solution. Mixtures of a plurality of silicate solutions may also be used. Alkali metal silicate solutions have the advantage that the alkali metal ions can readily be separated by washing. The silicate solution used in step b) preferably exhibits a modulus, i.e. weight ratio of metal oxide to silicon dioxide, of 1.5 to 4.5, preferably of 1.7 to 4.2, particularly preferably of 2 to 4.0. The viscosity may be established, for example, by evaporating conventional commercial silicate solutions or by dissolving the silicates in water.

In step c) of the method according to the invention, the silicate solution is added to the initial charge and the silicon dioxide is thus precipitated out. Care must here be taken to ensure that the acidulant is always present in excess. The silicate solution is therefore added such that the pH value of the reaction solution is always less than 2, preferably less than 1.5, particularly preferably less than 1, very particularly preferably less than 0.5 and especially preferably 0.001 to 0.5. If necessary, further acidulant may be added. The temperature of the reaction solution is maintained during the addition of the silicate solution by heating or cooling the precipitation vessel to 20 to 95° C., preferably 30 to 90° C., particularly preferably 40 to 80° C.

The inventors have found that particularly effectively filterable precipitates are obtained if the silicate solution enters the initial charge and/or precipitation suspension as drops. In a preferred embodiment of the present invention, care is therefore taken to ensure that the silicate solution enters the initial charge and/or precipitation suspension as drops. This may be achieved, for example, by dropwise addition of the silicate solution to the initial charge. The dispensing unit used may be arranged outside the initial charge/precipitation suspension and/or be immersed in the initial charge/precipitation suspension. Examples of suitable units known to the skilled worker are spraying units, droplet generators and prilling plates.

In a further particularly preferred embodiment, the initial charge/precipitation suspension is set in motion, for example by pumping or stirring, such that the flow velocity, measured in a zone which is defined by half the radius of the precipitation vessel±5 cm and the surface of the reaction solution to 10 cm below the reaction surface, is from 0.001 to 10 m/s, preferably 0.005 to 8 m/s, particularly preferably 0.01 to 5 m/s, very particularly 0.01 to 4 m/s, especially preferably 0.01 to 2 m/s and very especially preferably 0.01 to 1 m/s. Without being tied to any particular theory, the inventors are of the opinion that the incoming silicate solution is dispersed only slightly immediately after entry into the initial charge/precipitation suspension as a result of the low flow velocity.

This leads to rapid gelation at the shell of the incoming silicate solution drops or silicate solution streams, such that on the one hand the formation of colloidal silica is suppressed and the yield of filterable SiO₂ is greatly increased and on the other hand a sufficiently rapid change in pH is ensured, which is necessary if the high level of purity is to be achieved.

Optimum selection of the flow velocity of the initial charge/precipitation suspension may thus improve the purity of the product obtained.

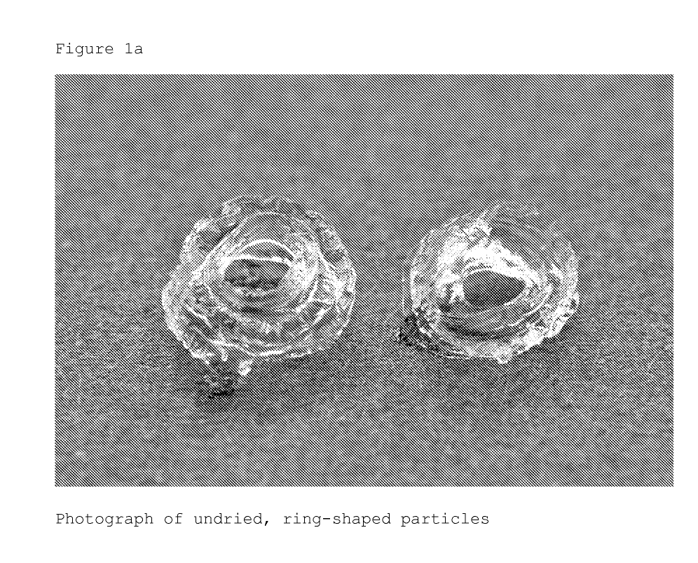

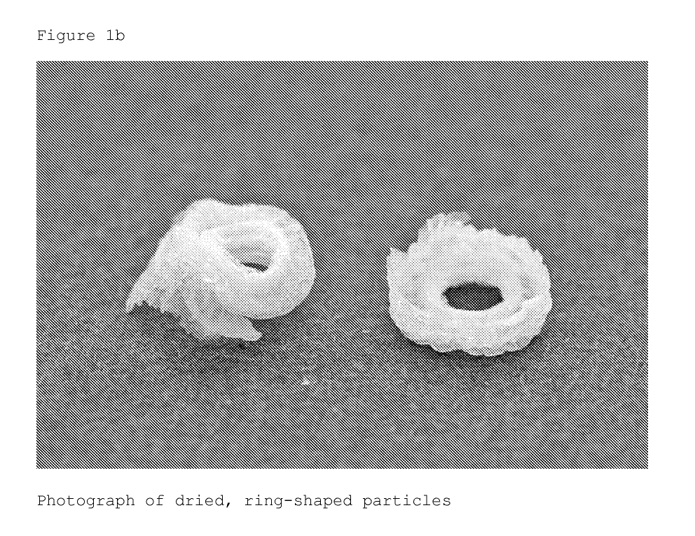

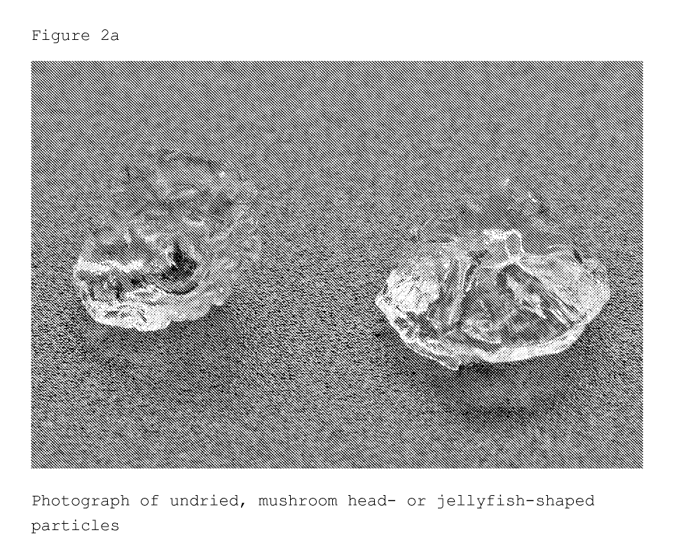

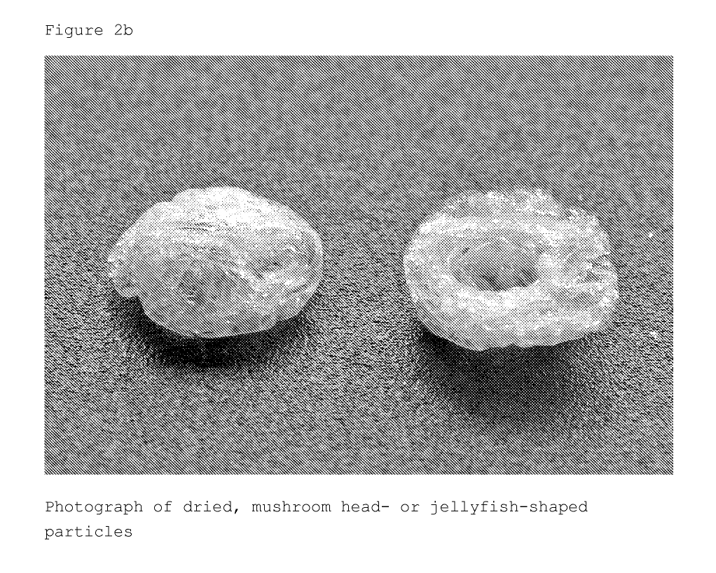

By combining an optimized flow velocity with as far as possible drop-form input of the silicate solution, this effect may be increased further such that an embodiment of the method according to the invention is preferred in which the silicate solution is introduced as drops into an initial charge/precipitation suspension with a flow velocity, measured in a zone extending through half the radius of the precipitation container±5 cm and the surface of the reaction solution to 10 cm below the reaction surface, of 0.001 to 10 m/s, preferably of 0.005 to 8 m/s, particularly preferably of 0.01 to 5 m/s, very particularly of 0.01 to 4 m/s, especially preferably of 0.01 to 2 m/s and very especially preferably of 0.01 to 1 m/s. It is furthermore possible in this manner to produce silicon dioxide particles which can very effectively be filtered (see FIGS. 1a and 2a). In contrast, in those methods in which an elevated flow velocity prevails in the initial charge/precipitation suspension, fine particles tend to form, which are very difficult to filter.

The present invention thereby also provides silicon dioxide particles which preferably have an average particle size d₅₀ of 0.1 to 10 mm, particularly preferably 0.3 to 9 mm and very particularly preferably 2 to 8 mm. In a first specific embodiment of the present invention these silicon dioxide particles are ring-shaped, i.e. they have a “hole” in the middle (see FIGS. 1a and 1b) and are thus comparable in shape to a miniature “donut”. The ring-shaped particles may adopt a largely round shape but also more of an oval shape.

In a second specific embodiment of the present invention these silicon dioxide particles have a shape which is comparable to a “mushroom head” or a “jellyfish”. That is to say, instead of the hole in the above-described “donut”-shaped particles, in the middle of the ring-shaped basic structure there is located a layer of silicon dioxide (see FIGS. 2a and 2b) which is curved to one side and preferably thin, i.e. thinner than the ring-shaped part and which covers the inner opening of the “ring”. If these particles were set down on the ground with their curved side downwards and observed perpendicularly from above, the particles would correspond to a shell with a curved base, a somewhat solid, i.e. thick, upper edge and a rather thinner base in the area of curvature.

The particles according to the invention of the above-described embodiments 1 and 2 may be produced by the method according to the invention. Without being tied to any particular theory, the inventors are of the opinion that the acidic conditions in the initial charge/reaction solution together with the addition of the silicate solution as drops lead to the drop of silicate solution starting to gel/precipitate immediately at its surface on contact with the acid, the drop simultaneously being deformed by the movement of the drop in the reaction solution/initial amount. Depending on the reaction conditions, in the case of slower drop movement it goes without saying that the “mushroom head”-shaped particles form here, whereas quicker drop movements lead instead to formation of the “donut”-shaped particles.

The precipitation according to the invention enables the obtainment of particles with different physicochemical properties. Since the particles of the above-described embodiments 1 (“donuts”) and 2 (“mushroom heads”) are already present before the washing step, the content of impurities may vary depending on whether the particles are further processed according to steps d) and e) of the method according to the invention. The present invention thus provides both high purity silicon dioxide particles of the embodiments 1 (“donuts”) and 2 (“mushroom heads”) as described below in the text and silicon dioxide particles of the embodiments 1 (“donuts”) and 2 (“mushroom heads”) which comprise greater proportions of impurities on the basis of the intended subsequent application. In this case, the proportion of impurities may be comparable to conventional commercial precipitated silicas such as for example Ultrasil 7000 GR from Evonik Degussa GmbH or Zeosil 1165 MP from Rhodia Chimie.

The present invention also provides a method, in which the silicon dioxide particles according to step c), i.e. the above-described silicon dioxide particles of embodiments 1 (“donuts”) and 2 (“mushroom heads”), are produced or further processed in at least one step.

The silicon dioxide obtained according to step c) is separated in step d) from the remaining constituents of the precipitation suspension. Depending on the filterability of the precipitate, this may proceed by conventional filtration methods, for example filter presses or rotary filters, known to a person skilled in the art. In the case of precipitates which are difficult to filter, separation may also proceed by centrifugation and/or by decanting off the liquid constituents of the precipitation suspension.

Once the supernatant has been separated off, the precipitate is washed, it being necessary to ensure by a suitable washing medium that the pH value of the washing medium during washing and thus also that of the silicon dioxide is less than 2, preferably less than 1.5, particularly preferably less than 1, very particularly preferably 0.5 and especially preferably 0.001 to 0.5. The washing medium used is preferably the acidulant used in steps a) and c) or mixtures thereof in dilute or undiluted form.

It is optionally possible, albeit not necessary, to add a chelating reagent to the washing medium or to stir the precipitated silicon dioxide in a washing medium containing a chelating reagent with a corresponding pH value of less than 2, preferably of less than 1.5, particularly preferably of less than 1, very particularly preferably of 0.5 and especially preferably of 0.001 to 0.5. Preferably, however, washing with the acidic washing medium proceeds immediately after separation of the silicon dioxide precipitate without further steps being performed.

Washing is preferably continued until the washing suspension consisting of silicon dioxide according to step c) and the washing medium no longer has a visible yellow/orange coloration. If the method according to the invention is performed in steps a) to d) without addition of a peroxide which forms a yellow/orange colored compound with Ti(IV) ions, a small sample of the washing suspension must be taken during each washing step and combined with an appropriate peroxide. This procedure is continued until the sample taken no longer has a visible yellow/orange coloration after addition of the peroxide. It must here be ensured that the pH value of the washing medium and thus also that of the silicon dioxide up to this point in time is less than 2, preferably less than 1.5, particularly preferably less than 1, very particularly preferably 0.5 and especially preferably 0.001 to 0.5.

The silicon dioxide washed in this manner is preferably further washed with distilled water or deionized water in an intermediate step d1), i.e. between step d) and e), until the pH value of the silicon dioxide obtained is 4 to 7.5 and/or the conductivity of the washing suspension is less than or equal to 9 μS/cm, preferably less than or equal to 5 μS/cm. This ensures that any acid residues adhering to the silicon dioxide have been sufficiently removed.

In the case of precipitates which are difficult to filter or wash, it may be advantageous to perform washing by passing the washing medium through the precipitate from below, for example in a close-meshed perforated basket.

All of the washing steps may preferably be performed at temperatures of 15 to 100° C.

In order to guarantee the indicator effect of the peroxide (yellow/orange coloration), it may be advisable to add further peroxide together with the washing medium until no yellow/orange coloration is any longer discernible and only then to continue washing with washing medium without peroxide.

The resultant high purity silicon dioxide can be dried and further processed. Drying may be carried out by means of any method known to a person skilled in the art, for example belt dryers, tray dryers, drum dryers etc.

It is advisable to grind the dried silicon dioxide in order to obtain an optimum particle size range for further processing to solar silicon. The methods for optional grinding of the silicon dioxide according to the invention are known to a person skilled in the art and may be looked up, for example, in Ullmann, 5th edition, B2, 5-20. Grinding preferably is carried out in fluidized bed opposed-jet mills in order to minimize or avoid contamination of the high purity silicon dioxide with metal abraded from the walls of the mill. Grinding parameters are selected such that the resultant particles have an average particle size d₅₀ of 1 to 100 μm, preferably of 3 to 30 μm, particularly preferably of 5 to 15 μm.

The silicon dioxides according to the invention are characterized in that their content of
a. aluminum amounts to between 0.001 ppm and 5 ppm, preferably 0.01 ppm to 0.2 ppm, particularly preferably 0.02 to 0.1, very particularly preferably 0.05 to 0.8 and especially preferably 0.1 to 0.5 ppm,
b. boron amounts to less than 1 ppm, preferably 0.001 ppm to 0.099 ppm, particularly preferably 0.001 ppm to 0.09 ppm and very particularly preferably 0.01 ppm to 0.08 ppm
c. calcium amounts to less than or equal to 1 ppm, 0.001 ppm to 0.3 ppm, particularly preferably 0.01 ppm to 0.3 ppm and very particularly preferably 0.05 ppm to 0.2 ppm
d. iron amounts to less than or equal to 5 ppm, preferably 0.001 ppm to 3 ppm, particularly preferably 0.05 ppm to 3 ppm and very particularly preferably 0.01 to 1 ppm, especially preferably 0.01 ppm to 0.8 ppm and very especially preferably 0.05 to 0.5 ppm
e. nickel amounts to less than or equal to 1 ppm, preferably 0.001 ppm to 0.8 ppm, particularly preferably 0.01 ppm to 0.5 ppm and very particularly preferably 0.05 ppm to 0.4 ppm
f. phosphorus amounts to less than 10 ppm, preferably less than 5, particularly preferably less than 1, very particularly preferably 0.001 ppm to 0.099 ppm, especially preferably 0.001 ppm to 0.09 ppm and very especially preferably 0.01 ppm to 0.08 ppm
g. titanium amounts to less than or equal to 1 ppm, preferably 0.001 ppm to 0.8 ppm, particularly preferably 0.01 ppm to 0.6 ppm and very particularly preferably 0.1 ppm to 0.5 ppm
h. zinc amounts to less than or equal to 1 ppm, preferably 0.001 ppm to 0.8 ppm, particularly preferably 0.01 ppm to 0.5 ppm and very particularly preferably 0.05 ppm to 0.3 ppm
   and in that the total of the abovementioned impurities plus sodium and potassium amounts to less than 10 ppm, preferably less than 4 ppm, particularly preferably less than 3 ppm, very particularly preferably 0.5 to 3 ppm and especially preferably 1 ppm to 3 ppm. In contrast to prior art silicon dioxides, such as for example from WO 2007/106860 A1, the method according to the invention results in silicon dioxides which exhibit very high purity with regard to a wide range of impurities.

The high purity silicon dioxides according to the invention may be present in the above-described forms, i.e. as “donut”-shaped particles or as “mushroom head”-shaped particles or in conventional particle form. However, they may also be press-molded into granules or briquets using methods known to a person skilled in the art. If the particles are ground, i.e. are present in conventional particle form, they may preferably have an average particle size d₅₀ of 1 to 100 μm, particularly preferably 3 to 30 μm and very particularly preferably 5 to 15 μm. The “donut”- or “mushroom head”-shaped particles are preferably present in an average particle size d₅₀ of 0.1 to 10 mm, particularly preferably 0.3 to 9 mm and very particularly preferably 2 to 8 mm.

The high purity silicon dioxides according to the invention may be further processed to yield high purity silicon for the solar industry. To this end, the silicon dioxides according to the invention may be reacted with high purity carbon or high purity sugars. Appropriate methods are known to a person skilled in the art for example from WO 2007/106860 A1.

The high purity silicon dioxide may also serve as a high purity raw material for the production of high purity silica glass for optical waveguides or glassware for laboratories and electronics and as a starting material for catalyst supports and the production of high purity silica sols for polishing slices of high purity silicon (wafers). In addition, the high purity silicon dioxide can be used to produce
glass blanks, for example “boules”
glass moldings, for example “overcladding tubes” or “core rods”, or as “inner cladding material” in light waveguides
core material in planar waveguides
melting crucibles
optical lenses and prisms and photomasks
diffraction grids, electrical, thermal and magnetic insulators
vessels and apparatuses for the chemical, pharmaceutical and semiconductor industry and solar industry
glass rods and glass tubes
   or
for coating of metals, plastic, ceramic or glass
as a filler in metals, glasses, polymers, elastomers and coatings
as a polishing agent for semiconductor material and electrical circuits
lamps
carrier material in the production of solar cells.

### Measuring Methods:

### Determination of the pH Value of the Precipitation Suspension

The method, based on DIN EN ISO 787-9, serves to determine the pH value of an aqueous suspension of silicon dioxide or the pH value of a largely SiO₂-free washing fluid.

Prior to carrying out the pH measurement, the pH-measuring instrument (Knick, type: 766 pH meter Calimatic with temperature sensor) and the pH electrode (combination electrode made by Schott, type N7680) have to be calibrated using the buffer solutions at 20° C. The calibrating function should be selected such that the two buffer solutions used include the expected pH value of the sample (buffer solutions with pH 4.00 and 7.00, pH 7.00 and pH 9.00 and optionally pH 7.00 and 12.00).

In steps a) and d) the pH value is determined at 20° C. In step c) measurement proceeds at the respective temperature of the reaction solution. To measure the pH value, the electrode is firstly rinsed off with deionized water, then with some of the suspension and is then immersed in the suspension. If the pH meter displays a constant value, the pH value is read off from the display.

Determination of Average Particle Size d₅₀ of High Purity Silicon Dioxides for Particle Sizes Smaller than 70 μm with Coulter LS 230 Laser Diffraction Instrument

### Description

The application of laser diffraction according to the Fraunhofer model for determining particle sizes is based on the phenomenon that particles scatter monochromatic light in all directions with a varying intensity pattern. This scattering is dependent on particle size. The smaller the particles, the larger the scattering angle.

### Procedure:

Once switched on, the Coulter LS 230 laser diffraction instrument needs to warm up for 1.5 to 2.0 hours to obtain constant measured values. The sample has to be very well shaken up prior to measurement. First of all the “Coulter LS 230” program is started by double-clicking. When doing this, care should be taken to ensure that “Use optical bench” is activated and the display on the Coulter instrument displays “Speed off”. Press the “Drain” button and keep it pressed until the water in the measurement cell has run away, then press the “On” button on the Fluid Transfer Pump and again keep it pressed until the water runs into the instrument overflow. Carry out this process twice in total. Then press the “Fill” button. The program starts up by itself and removes any air bubbles from the system, the speed being automatically increased and then decreased again. The pumping capacity selected for the measurement must be set.

To start the measurement, select “Measurement” “Measuring cycle”.

Measurement without PIDS

The measurement time amounts to 60 seconds, the waiting time 0 seconds. Then the computational model forming the basis of the laser diffraction is selected. In principle, a background measurement is carried out automatically prior to every measurement. After the background measurement the sample must be introduced into the measurement cell, until a concentration of 8 to 12% is reached. This is indicated by the program, by “OK” appearing at the top. To finish click on “Ready”. The program then carries out all the necessary steps itself and, after measurement, generates a particle size distribution for the sample investigated.

Determination of Average Particle Size d₅₀ of “Donut”-Shaped or “Mushroom Head”-Shaped Products

100 representative particles are selected and the diameter of each particle is determined under a light microscope. Since the particles may have an uneven shape, the diameter at the point of largest diameter is determined. The average value of all the particle diameters determined corresponds to the d₅₀ value.

### Determination of Dynamic Viscosity of Water Glass Using Falling Ball Viscosimeter

The dynamic viscosity of water glass is determined using a falling ball viscosimeter (Höppler Viscosimeter, Thermo Haake).

### Procedure

The water glass (approx. 45 cm³) is charged bubble-free into the fall tube of the falling ball viscosimeter (Thermo Haake, falling ball viscosimeter C) to below the tube end and the ball (Thermo Haake, ball set type 800-0182, ball 3, density δ_{K}=8.116 g/cm³, diameter dₓ=15.599 mm, ball-specific constant K=0.09010 mPa*s*cm/g) is then introduced. The temperature of the viscosimeter is accurately adjusted to 20±0.03° C. by means of a circulating thermostat (Jalubo 4). Prior to measurement the ball runs through the tube once in order thoroughly to mix the water glass. After an interval of 15 minutes the first measurement begins.

The measuring part engages in a defined manner in the 10° position at the instrument foot. By turning the measuring part through 180° the ball is brought into the starting position for measurement. The falling time t through the measuring section A-B is determined by means of a manual stopwatch. The measurement time begins when the lower ball periphery touches the intended top annular mark A, which has to appear to the observer as a line. The measurement time ends when the lower ball periphery reaches the lower annular mark B, which has likewise to appear as a line. By turning the measuring part back through 180°, the ball falls back into the starting position. After an interval of 15 minutes a second measurement takes place as described. Repeatability is ensured if the measured values differ from one another by no more than 0.5%.

The dynamic viscosity of the water glass (η_{WGL}) is calculated in mPa*s according to the numerical value equation

η_{WGL}=K*(δ_{K}−δ_{WGL})*t
Ball constant: K=0.09010 mPa*s*cm³/g
Ball density: δ_{K}=8.116 g/cm³
Water glass density: δ_{WGL} in g/cm³
t=time of descent of ball in s
   with an accuracy of one decimal place.
   100 mPa*s correspond to 1 poise.

### Determination of Conductivity of Washing Medium

The electrical conductivity of an aqueous suspension of silicon dioxide, or the electrical conductivity of a largely SiO₂-free washing fluid, is determined at room temperature on the basis of DIN EN ISO 787-14.

### Determination of Flow Velocity

Flow velocity is determined by means of the volumetric flow meter P-670-M with water flow probe from PCE Group. The probe is positioned in an area of the reactor which is defined widthwise by half the reactor radius±5 cm and heightwise from the surface of the initial amount/precipitation suspension to 10 cm below the surface of the initial amount/precipitation suspension. The instructions for the meter should be observed.

### Determination of Content of Impurities:

Description of method for determining trace elements in silica by means of high-resolution inductively coupled plasma mass spectrometry (HR-ICPMS) (as per test report A080007580)

1-5 g of sample material are weighed out into a PFA beaker to an accuracy of ±1 mg. 1 g of mannitol solution (approx. 1%) and 25-30 g of hydrofluoric acid (approx. 50%) are added. After brief swirling, the PFA beaker is heated to 110° C. in a heating block, such that the silicon contained in the sample slowly evaporates as hexafluorosilicic acid, the excess hydrofluoric acid also slowly evaporating. The residue is dissolved with 0.5 ml of nitric acid (approx. 65%) and a few drops of hydrogen peroxide solution (approx. 30%) for roughly 1 hour and made up to 10 g with ultrapure water.

To determine the trace elements, 0.05 ml or 0.1 ml are taken from the digestion solutions, in each case transferred into a polypropylene sample tube, combined with 0.1 ml of indium solution (c=0.1 mg/l) as internal standard and made up to 10 ml with dilute nitric acid (approx. 3%). The production of these two sample solutions in different dilutions serves for internal quality assurance, i.e. verifying whether errors have been made during measurement or sample preparation. In principle, it is also possible to work with just one sample solution.

Four calibration solutions (c=0.1; 0.5; 1.0; 5.0 μg/l) are produced from multielement stock solutions (c=10 mg/l) containing all the elements to be analyzed apart from indium, again with the addition of 0.1 ml of indium solution (c=0.1 mg/l) to make up to a final volume of 10 ml. In addition, blank solutions are produced with 0.1 ml of indium solution (c=0.1 mg/l) to make up to a final volume of 10 ml.

The element contents in the blank, calibration and sample solutions are quantified using High-Resolution Inductively Coupled Mass Spectrometry (HR-ICPMS) and external calibration. Measurement proceeds with a mass resolution (m/Δm) of at least 4000 or 10000 for the elements potassium, arsenic and selenium.

The following examples are intended to illustrate the present invention in greater detail, but not to limit it in any manner.

### COMPARATIVE EXAMPLE 1

On the basis of example 1 of WO 2007/106860 A1 397.6 g of water glass (27.2 wt. % SiO₂ and 8.0 wt. % Na₂O) were mixed with 2542.4 g of deionized water. The diluted water glass was then passed through a column with an internal diameter of 41 mm and a length of 540 mm, filled with 700 ml (500 g dry weight) of Amberlite IRA 743 in water. After 13.5 min a pH value of greater than 10 was measured at the column outlet, meaning that at this point the first water glass has passed through the column. A sample totaling 981 g of purified water glass, taken between the 50th and 74th minutes, was used for the further tests.

The analytical data for the water glass before and after purification may be found in table 1 below:

TABLE 1

| | | Water glass | Water glass |
|---|---|---|---|
| | Content | upstream of ion | downstream of |
| Impurity | in | exchanger | ion exchanger |
| Aluminum | ppm | 31 | 31 |
| Boron | ppm | <1 | <1 |
| Calcium | ppm | 3 | 3 |
| Iron | ppm | 8 | 7 |
| Nickel | ppm | <0.3 | <0.3 |
| Phosphorus | ppm | <10 | <10 |
| Titanium | ppm | 8 | 2 |
| Zinc | ppm | <1 | <1 |

The data from table 1 show that the step described as essential in WO 2007/106860 A1 of purifying the water glass over Amberlite IRA 743 does not have any great purifying effect with conventional commercial water glass and merely brings about a slight improvement in titanium content.

The purified water glass was further processed as per example 5 of WO 2007/106860 A1 to yield SiO₂. To this end, 700 g of the water glass were acidified with 10% sulfuric acid in a 2000 ml round-bottomed flask with stirring. The initial pH value was 11.26. After the addition of 110 g of sulfuric acid, the gelling point was reached at pH 7.62 and 100 g of deionized water were added so as to re-establish stirrability of the suspension. After the addition of a total of 113 g of sulfuric acid, a pH value of 6.9 was reached and stirring was carried out for 10 minutes at this pH value. Thereafter filtering was performed using a 150 mm diameter Büchner funnel. The product was very difficult to filter. After washing five times with in each case 500 ml of deionized water, conductivity was 140 μS/cm. The resultant filter cake was dried for 2.5 days at 105° C. in a circulating air drying cabinet, it being possible to obtain 25.4 g of dry product. The analytical results may be found in table 2.

### EXAMPLE 1

### According to the Invention

2500 g of 16.3% sulfuric acid and 16 g of 35% H₂O₂ were introduced into a 3000 ml beaker (diameter 152 mm, height 210 mm) and 750 g of water glass (8.05% Na₂O, 26.7% SiO₂, density 1.3505 g/ml, viscosity 0.582 poise) were added dropwise with slow stirring. The stirrer speed was 50 rpm. During dropwise addition, gelled particles formed immediately in the shape of mushroom heads (jellyfish shape) and fell to the bottom. The structures are thin-walled and sedimented very well. The supernatant solution developed a yellow color and does not exhibit any cloudiness. After completion of water glass addition, stirring was continued for 20 minutes at 50 rpm.

The suspension was worked up by decanting the supernatant solution. A mixture of 1000 ml of deionized water and 50 ml of 96% sulfuric acid was added to the solid material and heated to over 70-80° C. in a heating bath.

After the suspension had cooled down somewhat, the supernatant solution was decanted again. This procedure was repeated ten times.

Then dilution was performed with in each case 1000 ml portions of deionized water and decanting was performed until a pH value of 5.5 was reached. Then further washing was performed until a conductivity of 1 μS/cm was established.

The product was dried overnight in a porcelain dish at 105° C. in a circulating air drying cabinet. 193 g of dried product were obtained, corresponding to a yield of 96.4%. Some of the sample was sent for analysis.

TABLE 2

| | | SiO₂ as per | SiO₂ according to |
|---|---|---|---|
| | Content | comparative | the invention as |
| Impurity | in | example 1 | per example 1 |
| Aluminum | ppm | 720 | <5 |
| Boron | ppm | 1 | <1 |
| Calcium | ppm | 42 | <1 |
| Iron | ppm | 170 | 2 |
| Nickel | ppm | <0.3 | 0.8 |
| Phosphorus | ppm | <10 | <10 |
| Titanium | ppm | 57 | <0.5 |
| Zinc | ppm | <3 | <1 |
| Sodium | ppm | 6800 | <10 |
| Potassium | ppm | 34 | <10 |

The results from table 2 show that, although the silicon dioxide obtained in the comparative example has a low boron and phosphorus content, as disclosed in WO 2007/106860 A1, the content of other impurities is so high that the silicon dioxide is not suitable as a starting material for producing solar silicon.

The silicon dioxide produced by the method according to the invention has an impurities content of less than 10 ppm on the basis of the polyvalent elements iron, titanium and aluminum, which are the most difficult to remove. Table 2 also indicates that the impurity levels of elements which are critical in the production of solar silicon are also within an acceptable range. It is thus clear that, contrary to the teaching of the prior art, it is possible by the method according to the invention, without a chelating reagent or using ion exchange columns, to produce from conventional commercial water glass and conventional commercial sulfuric acid a silicon dioxide which is highly suitable as a starting material for solar silicon thanks to its impurities profile.

1. Method for the production of high purity silicon dioxide comprising the following steps:
a. producing an initial charge of an acidulant, or an acidulant with water, with a pH value of less than 2
b. providing a silicate solution with a viscosity of 0.2 to 2 poise
c. adding the silicate solution from step b) to the initial charge from step a) to provide a precipitation suspension, such that the pH value of the precipitation suspension remains at all times at a value of less than 2
d. separating and washing the resultant silicon dioxide, with a washing medium having a pH value of less than 2
e. drying the resultant silicon dioxide.

2. Method according to claim 1, wherein the flow velocity of the initial charge or of the precipitation suspension in the reactor amounts to 0.001 to 10 m/s.

3. Method according to claim 1, wherein, in addition to the acidulant, the initial charge in step a) also contains a peroxide, which under acidic conditions combines with titanium(IV) ions to form a yellow/orange compound.

4. Method according to claim 1, comprising the dropwise addition of the silicate solution in step c).

5. Method according to claim 1, wherein the silicon dioxide particles obtained after step c) are ring-shaped or take the form of a mushroom head, i.e. a ring-shaped basic structure whose internal hole is covered by a layer of silicon dioxide curved to one side.

6. Method according to claim 1, wherein no further steps are carried out between step c) and separation of the silicon dioxide and washing with a washing medium with a pH value of less than 2.

7. Method according to claim 1, wherein, after washing with a washing medium with a pH value of less than 2, additional washing takes place with distilled water, until the pH value of the resultant silicon dioxide is 4 to 7.5, or the conductivity of the washing suspension is less than or equal to 9 μS/cm, or a combination thereof.

8. Method according to claim 1, wherein the acidulant comprises hydrochloric acid, phosphoric acid, nitric acid, sulfuric acid, chlorosulfonic acid, sulfuryl chloride or perchloric acid in concentrated or dilute form or comprises mixtures of the above-stated acids.

9. Method according to claim 1, wherein the method does not comprise a calcining step.

10. Silicon dioxide, wherein it is ring-shaped in form.

11. Silicon dioxide, wherein it takes the form of a mushroom head, i.e. a ring-shaped basic structure whose internal hole is covered by a layer of silicon dioxide curved to one side.

12. Silicon dioxide according to claim 10, wherein the content of
a. aluminum is between 0.01 and 5 ppm
b. boron is less than 1 ppm
c. calcium is less than or equal to 1 ppm
d. iron is less than or equal to 5 ppm
e. nickel is less than or equal to 1 ppm
f. phosphorus is less than 1 ppm
g. titanium is less than or equal to 5 ppm
h. zinc is less than or equal to 1 ppm
and wherein the total of the abovementioned impurities plus sodium and potassium amounts to less than 10 ppm.

13. Silicon dioxide according to claim 12, wherein it has an average particle size d₅₀ of 0.1 to 10 mm.

14. Silicon dioxide obtained using a method according to claim 1.

15. Article of manufacture comprising silicon dioxide according to claim 14.

16. Article of manufacture according to claim 15, wherein the article is selected from elemental silicon, high purity silica glass, an optical waveguide, glassware, a high purity silica sol, a silicon wafer polish, a glass blank, a glass molding, a light waveguide, a planar waveguide, a melting crucibles, an optical lens, a prism, a photomask, a diffraction grating, an electrical insulator, a thermal insulator, a magnetic insulator, a vessel, a glass rod, a glass tube, a coating material, a filler, a semiconductor polish, an electrical circuit polish, a lamp, or a solar cell.

17. Silicon dioxide according to claim 11, wherein the content of
a. aluminum is between 0.01 and 5 ppm
b. boron is less than 1 ppm
c. calcium is less than or equal to 1 ppm
d. iron is less than or equal to 5 ppm
e. nickel is less than or equal to 1 ppm
f. phosphorus is less than 1 ppm
g. titanium is less than or equal to 5 ppm
h. zinc is less than or equal to 1 ppm
and wherein the total of the abovementioned impurities plus sodium and potassium amounts to less than 10 ppm.

18. Silicon dioxide according to claim 17, wherein it has an average particle size d₅₀ of 0.1 to 10 mm.
